(19) United States
(12) Patent Application Publication
(10) Pub. No.: US 2023/0183610 A1
(43) Pub. Date: Jun. 15, 2023

(54) LAUNDRY COMPOSITION

(71) Applicant: Conopco, Inc., d/b/a UNILEVER, Englewood Cliffs, NJ (US)

(72) Inventors: Thatiana Guisolphe CASTRO, São Paulo (BR); Arlene FICHE, São Paulo (BR)

(73) Assignee: Conopco, Inc., d/b/a UNILEVER, Englewood Cliffs, NJ (US)

(21) Appl. No.: 17/924,771

(22) PCT Filed: May 13, 2021
(86) PCT No.: PCT/EP2021/062791

§ 371 Date: Nov. 11, 2022

(30) Foreign Application Priority Data
May 14, 2020 (EP) 20174766.4

(51) Int. Cl. C11D 3/00; C11D 11/00; C11D 3/50; C11D 3/34; C11D 3/20

(52) U.S. Cl. CPC C11D 3/0015; C11D 11/0017; C11D 3/505; C11D 3/3463; C11D 3/2013

(57) ABSTRACT

A process for producing a dilute fabric conditioner, the fabric conditioner comprising: a) 0.5 to 4 wt. % fabric softening active; b) 0.1 to 4 wt. % perfume microcapsules; and c) 0.01 to 4 wt. % polymer; the process comprising the steps of: i) dispersing the perfume microcapsules in water, ii) add the fabric softening active; and iii) adding the polymer.

### FIELD OF THE INVENTION

The present invention is in the field of dilute fabric conditioners comprising perfume microcapsules and a processes for manufacturing dilute fabric conditioners comprising perfume microcapsules.

### BACKGROUND OF THE INVENTION

Fabric conditioners are used by consumers for two main purposes: softening and fragrance. Perfume microcapsules are commonly included in concentrated fabric conditioners, for example fabric conditioners comprising more than 8 wt. % fabric softening active. Perfume microcapsules delay the release of perfume, providing longer lasting fragrance. However, the inclusion of perfume microcapsules in dilute fabric conditioner formulations leads to instability in the formulation.

There is a need for a process to enable the manufacture of stable, dilute fabric conditioners which comprise perfume microcapsules.

### SUMMARY OF THE INVENTION

In a first aspect of the present invention, there is provided a process for producing a dilute fabric conditioner, the fabric conditioner comprising:
a. 0.5 to 4 wt. % quaternary ammonium fabric softening active;
b. 0.1 to 4 wt. % perfume microcapsules; and
c. 0.01 to 4 wt. % cationic polymer;
the process comprising the steps of:
i. Dispersing the perfume microcapsules in water;
ii. Add the fabric softening active; and
iii. Adding the polymer.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The process of the present invention surprisingly leads to greatly improved stability in dilute fabric conditioning formulations. The process is of particular importance when shear is exerted on the formulation after discharge from the main mixing vessel. The shear may for example be created by narrow pipes or from the filing lines, during the filling process.

The process is for the manufacture compositions comprising 0.5 to 4 wt. % of the composition cationic fabric softening active, 0.05 to 4 wt. % of the composition perfume microcapsules and 0.01 to 4 wt. % of the composition cationic polymers. Other ingredients may be present.

The process consists of the steps of:
i. Dispersing the perfume microcapsules in water;
ii. Adding the cationic fabric softening active; and
iii. Adding the cationic polymer.

Other ingredients may be added at any stage of the process. Preferably the cationic polymer is the last ingredient, other than water, to be added during the production process. In other words, only water is optionally added to the formulation following the addition of the cationic polymer.

Preferably the fabric softening active is pre-dispersed in water prior to addition to the main mix, i.e. the fabric softening active is added in the form of a pre-mix with water. Preferably the pre-mix is prepared at a temperature above 50° C., more preferably above 60° C.

In one aspect of the present invention is provided a stable, dilute fabric conditioning composition as described herein, obtained by the process described herein. In employing this process, improved stability is achieved.

The dilute fabric conditioners made by the process of the present invention comprise cationic fabric softening actives. For the purposes of the present invention, dilute fabric conditioning compositions comprise up to about 4%, for example 0.5 to 4% by weight of the composition, cationic softening actives. Preferably the fabric conditioners of the present invention comprise more than 1 wt. % cationic fabric softening active, more preferably more than 1.5 wt. % cationic fabric softening active. Preferably the fabric conditioners of the present invention comprise less than 3.75 wt. % cationic fabric softening active, more preferably less than 3.5 wt. % cationic fabric softening active. Suitably the fabric conditioners comprise 0.5 to 4 wt. % cationic fabric softening active, preferably 1 to 3.75 wt. % cationic fabric softening active and more preferably 1.5 to 3.5 wt. % cationic fabric softening active.

The preferred softening actives for use in fabric conditioner compositions of the invention are quaternary ammonium compounds (QAC).

The QAC preferably comprises at least one chain derived from fatty acids, more preferably at least two chains derived from a fatty acids. Generally fatty acids are defined as aliphatic monocarboxylic acids having a chain of 4 to 28 carbons. Fatty acids may be derived from various sources such as tallow or plant sources. Preferably the fatty acid chains are derived from plant sources, for example plam. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are so called “ester quats”. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55 wt. %, or even no more that 45 wt. % of the fabric softening compound and at least 10 wt. % of the monoester linked component.

A first group of ester linked quaternary ammonium compounds suitable for use in the present invention is represented by formula (I):

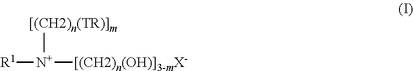

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X− is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Suitable actives include soft quaternary ammonium actives such as Stepantex VT90, Rewoquat WE18 (ex-Evonik) and Tetranyl L1/90N, Tetranyl L190 SP and Tetranyl L190 S (all ex-Kao).

Also suitable are actives rich in the di-esters of triethanolammonium methylsulfate, otherwise referred to as “TEA ester quats”.

Commercial examples include Preapagen™ TQL (ex-Clariant), and Tetranyl™ AHT-1 (ex-Kao), (both di-[hardened tallow ester] of triethanolammonium methylsulfate), AT-1 (di-[tallow ester] of triethanolammonium methylsulfate), and L5/90 (di-[palm ester] of triethanolammonium methylsulfate), (both ex-Kao), and Rewoquat™ WE15 (a di-ester of triethanolammonium methylsulfate having fatty acyl residues deriving from 010-C20 and C16-C18 unsaturated fatty acids) (ex-Evonik).

A second group of ester linked quaternary ammonium compounds suitable for use in the invention is represented by formula (II):

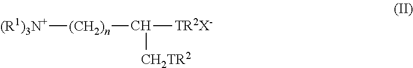

wherein each R1 group is independently selected from C1 to C4 alkyl, hydroxyalkyl or C2 to C4 alkenyl groups; and wherein each R₂ group is independently selected from C8 to C28 alkyl or alkenyl groups; and wherein n, T, and X− are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding mono-ester.

A third group of ester linked quaternary ammonium compounds QACs suitable for use in the invention is represented by formula (III):

(R¹)₂—N⁺—[(CH₂)ₙ-T-R²]₂ X⁻ (III)

wherein each R1 group is independently selected from C1 to C4 alkyl, or C2 to C4 alkenyl groups; and wherein each R₂ group is independently selected from C8 to C28 alkyl or alkenyl groups; and n, T, and X− are as defined above. Preferred materials of this third group include bis(2-tallowoyloxyethyl)dimethyl ammonium chloride, partially hardened and hardened versions thereof.

A particular example of the third group of ester linked quaternary ammonium compounds is represented the by the formula (IV):

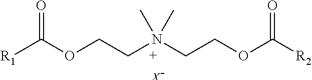

A fourth group of ester linked quaternary ammonium compounds suitable for use in the invention are represented by formula (V)

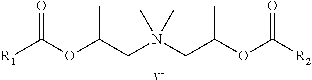

R1 and R2 are independently selected from 010 to C22 alkyl or alkenyl groups, preferably C14 to C20 alkyl or alkenyl groups. X− is as defined above.

The iodine value of the ester linked quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of ester linked quaternary ammonium materials present in the composition, the iodine value, referred to above, represents the mean iodine value of the parent fatty acyl compounds or fatty acids of all of the ester linked quaternary ammonium materials present. Likewise, if there are any saturated ester linked quaternary ammonium materials present in the composition, the iodine value represents the mean iodine value of the parent acyl compounds of fatty acids of all of the ester linked quaternary ammonium materials present.

Iodine value as used in the context of the present invention refers to, the fatty acid used to produce the ester linked quaternary ammonium compounds, the measurement of the degree of unsaturation present in a material by a method of nmr spectroscopy as described in Anal. Chem, 34, 1136 (1962) Johnson and Shoolery.

The dilute fabric conditioners made by the process of the present invention comprise perfume microcapsules. The compositions comprise 0.05 to 4 wt. % of the composition, perfume microcapsules, more preferably 0.75 to 3 wt. % perfume microcapsules and most preferably 0.9 to 2.5 wt. % microcapsules by weight of the composition. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof. Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The compositions of the present invention preferably comprise friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components contained in a microcapsule are blooming perfume components and substantive perfume components. Blooming perfume components are defined by a boiling point less than 250° C. and a Log P greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a Log P greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

The dilute fabric conditioners made by the process of the present invention comprise a cationic polymer. This refers to polymers having an overall positive charge at a neutral pH (pH 7). The cationic polymers provide increased viscosity.

The cationic polymer may be naturally derived or synthetic. Examples of suitable cationic polymers include: cationic acrylate polymers, cationic amino resins, cationic urea resins, and cationic polysaccharides, including: cationic celluloses, cationic guars and cationic starches.

The cationic polymer of the present invention may be categorised as a polysaccharide-based cationic polymer or non-polysaccharide based cationic polymers.

Polysaccharide-Based Cationic Polymers:

Polysacchride based cationic polymers include cationic celluloses, cationic guars and cationic starches. Polysaccharides are polymers made up from monosaccharide monomers joined together by glycosidic bonds.

The cationic polysaccharide-based polymers present in the compositions of the invention have a modified polysaccharide backbone, modified in that additional chemical groups have been reacted with some of the free hydroxyl groups of the polysaccharide backbone to give an overall positive charge to the modified cellulosic monomer unit.

A preferred polysaccharide polymer is cationic cellulose. This refers to polymers having a cellulose backbone and an overall positive charge.

Cellulose is a polysaccharide with glucose as its monomer, specifically it is a straight chain polymer of D-glucopyranose units linked via beta-1,4 glycosidic bonds and is a linear, non-branched polymer.

The cationic cellulose-based polymers of the present invention have a modified cellulose backbone, modified in that additional chemical groups have been reacted with some of the free hydroxyl groups of the polysaccharide backbone to give an overall positive charge to the modified cellulose monomer unit.

A preferred class of cationic cellulose polymers suitable for this invention are those that have a cellulose backbone modified to incorporate a quaternary ammonium salt. Preferably the quaternary ammonium salt is linked to the cellulose backbone by a hydroxyethyl or hydroxypropyl group. Preferably the charged nitrogen of the quaternary ammonium salt has one or more alkyl group substituents.

Example cationic cellulose polymers are salts of hydroxyethyl cellulose reacted with trimethyl ammonium substituted epoxide, referred to in the field under the International Nomenclature for Cosmetic Ingredients as Polyquatemium 10 and is commercially available from the Amerchol Corporation, a subsidiary of The Dow Chemical Company, marketed as the Polymer LR, JR, and KG series of polymers. Other suitable types of cationic celluloses include the polymeric quaternary ammonium salts of hydroxyethyl cellulose reacted with lauryl dimethyl ammonium-substituted epoxide referred to in the field under the International Nomenclature for Cosmetic Ingredients as Polyquatemium 24. These materials are available from Amerchol Corporation marketed as Polymer LM-200.

Typical examples of preferred cationic cellulosic polymers include cocodimethylammonium hydroxypropyl oxyethyl cellulose, lauryldimethylammonium hydroxypropyl oxyethyl cellulose, stearyldimethylammonium hydroxypropyl oxyethyl cellulose, and stearyldimethylammonium hydroxyethyl cellulose; cellulose 2-hydroxyethyl 2-hydroxy 3-(trimethyl ammonio) propyl ether salt, polyquaternium-4, polyquaternium-10, polyquaternium-24 and polyquaternium-67 or mixtures thereof.

More preferably the cationic cellulosic polymer is a quaternised hydroxy ether cellulose cationic polymer. These are commonly known as polyquaternium-10. Suitable commercial cationic cellulosic polymer products for use according to the present invention are marketed by the Amerchol Corporation under the trade name UCARE.

The counterion of the cationic polymer is freely chosen from the halides: chloride, bromide, and iodide; or from hydroxide, phosphate, sulphate, hydrosulphate, ethyl sulphate, methyl sulphate, formate, and acetate.

Non Polysaccharide-Based Cationic Polymers:

A non-polysaccharide-based cationic polymer is comprised of structural units, these structural units may be non-ionic, cationic, anionic or mixtures thereof. The polymer may comprise non-cationic structural units, but the polymer must have a net cationic charge.

The cationic polymer may consists of only one type of structural unit, i.e., the polymer is a homopolymer. The cationic polymer may consists of two types of structural units, i.e., the polymer is a copolymer. The cationic polymer may consists of three types of structural units, i.e., the polymer is a terpolymer. The cationic polymer may comprises two or more types of structural units. The structural units may be described as first structural units, second structural units, third structural units, etc. The structural units, or monomers, may be incorporated in the cationic polymer in a random format or in a block format.

The cationic polymer may comprise a nonionic structural units derived from monomers selected from: (meth)acrylamide, vinyl formamide, N, N-dialkyl acrylamide, N, N-dialkylmethacrylamide, C1-C12 alkyl acrylate, C1-C12 hydroxyalkyl acrylate, polyalkylene glyol acrylate, C1-C12 alkyl methacrylate, C1-C12 hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and mixtures thereof.

The cationic polymer may comprise a cationic structural units derived from monomers selected from: N, N-dialkylaminoalkyl methacrylate, N, N-dialkylaminoalkyl acrylate, N, N-dialkylaminoalkyl acrylamide, N, N-dialkylaminoalkylmethacrylamide, methacylamidoalkyl trialkylammonium salts, acrylamidoalkylltrialkylamminium salts, vinylamine, vinylimine, vinyl imidazole, quaternized vinyl imidazole, diallyl dialkyl ammonium salts, and mixtures thereof.

Preferably, the cationic monomer is selected from: diallyl dimethyl ammonium salts (DADMAS), N, N-dimethyl aminoethyl acrylate, N,N-dimethyl aminoethyl methacrylate (DMAM), [2-(methacryloylamino)ethyl]trl-methylammonium salts, N, N-dimethylaminopropyl acrylamide (DMAPA), N, N-dimethylaminopropyl methacrylamide (DMAPMA), acrylamidopropyl trimethyl ammonium salts (APTAS), methacrylamidopropyl trimethylammonium salts (MAPTAS), quaternized vinylimidazole (QVi), and mixtures thereof.

The cationic polymer may comprise an anionic structural unit derived from monomers selected from: acrylic acid (AA), methacrylic acid, maleic acid, vinyl sulfonic acid, styrene sulfonic acid, acrylamidopropylmethane sulfonic acid (AMPS) and their salts, and mixtures thereof.

The cationic polymer may be a crosslinked water swellable cationic polymer, for example a crosslinked water swellable cationic polymer formed from at least one monoethylenically unsaturated cationic monomer and optionally non-ionic and or anionic monoethylenically unsaturated monomers wherein said cationic polymer thickener has a water soluble polymeric fraction of less than 25% by weight of the total polymer, and a cross-linking agent concentration of from 500 ppm to 5000 ppm relative to the polymer. Suitable cross linked water swellable polymers are available from SNF under the trade name Flosoft.

Some cationic polymers disclosed herein will require stabilisers i.e. materials which will exhibit a yield stress in the composition of the present invention. Such stabilisers may be selected from: thread like structuring systems for example hydrogenated castor oil or trihydroxystearin e.g. Thixcin ex. Elementis Specialties, crosslinked polyacrylic acid for example Carbopol ex. Lubrizol and gums for example carrageenan.

Preferably the cationic polymer is selected from; cationic polysaccharides and acrylate polymers. More preferably the cationic polymer is a cationic acrylate polymer.

The molecular weight of the cationic polymer is preferably greater than 20 000 g/mol, more preferably greater than 25 000 g/mol. The molecular weight is preferably less than 2 000 000 g/mol, more preferably less than 1 000 000 g/mol.

The fabric conditioning compositions made by the process of the present invention a preferably comprise cationic polymer at a level of 0.01 to 4 w.t % of the composition, preferably 0.05 to 3 wt. % of the formulation, more preferably 0.08 to 2 wt. % of the composition.

The dilute fabric conditioners made by the process of the present invention may preferably comprise free perfume in addition to the perfume microcapsules.

The compositions preferably comprise 0.05 to 4 wt. % of the composition, free perfume, more preferably 0.75 to 3 wt. % free perfume most preferably 0.9 to 2.5 wt. % of the composition.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The compositions made by the process of the present invention may further comprise a nonionic surfactant. Typically these can be included for the purpose of stabilising the compositions. Suitable nonionic surfactants include addition products of ethylene oxide and/or propylene oxide with fatty alcohols, fatty acids and fatty amines. Any of the alkoxylated materials of the particular type described hereinafter can be used as the nonionic surfactant.

Suitable surfactants are substantially water soluble surfactants of the general formula (VII):

R—Y—(C₂H₄O)_{z}—CH₂—CH₂—OH (VII)

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, preferably 10 to 20, e.g. 14 to 18 carbon atoms.

In the general formula for the ethoxylated nonionic surfactant, Y is typically:

—O—, —C(O)O—, —C(O)N(R)— or —C(O)N(R)R—

in which R has the meaning given above for formula (VII), or can be hydrogen; and Z is at least about 8, preferably at least about 10 or 11.

Preferably the nonionic surfactant has an HLB of from about 7 to about 20, more preferably from 10 to 18, e.g. 12 to 16. Genapol™ C200 (Clariant) based on coco chain and 20 EO groups is an example of a suitable nonionic surfactant.

If present, the nonionic surfactant is present in an amount from 0.001 to 4 wt. %, more preferably 0.05 to 3 wt. %, based on the total weight of the composition.

A class of preferred non-ionic surfactants include addition products of ethylene oxide and/or propylene oxide with fatty alcohols, fatty acids and fatty amines. These are preferably selected from addition products of (a) an alkoxide selected from ethylene oxide, propylene oxide and mixtures thereof with (b) a fatty material selected from fatty alcohols, fatty acids and fatty amines.

Suitable surfactants are substantially water soluble surfactants of the general formula (VIII):

R—Y—(C₂H₄O)_{z}—CH₂—CH₂—OH (VIII)

where R is selected from the group consisting of primary, secondary and branched chain alkyl and/or acyl hydrocarbyl groups (when Y=—C(O)O, R≠an acyl hydrocarbyl group); primary, secondary and branched chain alkenyl hydrocarbyl groups; and primary, secondary and branched chain alkenyl-substituted phenolic hydrocarbyl groups; the hydrocarbyl groups having a chain length of from 10 to 60, preferably 10 to 25, e.g. 14 to 20 carbon atoms.

In the general formula for the ethoxylated nonionic surfactant, Y is typically:

—O—, —C(O)O—, —C(O)N(R)— or —C(O)N(R)R—

in which R has the meaning given above for formula (VIII), or can be hydrogen; and Z is at least about 6, preferably at least about 10 or 11.

Lutensol™ AT25 (BASF) based on C16:18 chain and 25 EO groups is an example of a suitable non-ionic surfactant. Other suitable surfactants include Renex 36 (Trideceth-6), ex Croda; Tergitol 15-S3, ex Dow Chemical Co.; Dihydrol LT7, ex Thai Ethoxylate ltd; Cremophor C040, ex BASF and Neodol 91-8, ex Shell.

The compositions made by the process of the present invention may comprise a fatty complexing agent. When employed, they are typically present at from 0.01 to 4 wt. % and particularly at from 0.05 to 3 wt. %, based on the total weight of the composition.

Especially suitable fatty complexing agents include fatty alcohols and fatty acids. Of these, fatty alcohols are most preferred.

Without being bound by theory it is believed that the fatty complexing material improves the viscosity profile of the composition by complexing with mono-ester component of the fabric conditioner material thereby providing a composition which has relatively higher levels of di-ester and tri-ester linked components. The di-ester and tri-ester linked components are more stable and do not affect initial viscosity as detrimentally as the mono-ester component.

It is also believed that the higher levels of mono-ester linked component present in compositions comprising quaternary ammonium materials based on TEA may destabilise the composition through depletion flocculation. By using the fatty complexing material to complex with the mono-ester linked component, depletion flocculation is significantly reduced.

In other words, the fatty complexing agent at the increased levels, as required by the present invention, “neutralises” the mono-ester linked component of the quaternary ammonium material. This in situ di-ester generation from mono-ester and fatty alcohol also improves the softening of the composition.

Preferred fatty acids include tallow fatty acid or vegetable fatty acids, particularly preferred are hardened tallow fatty acid or hardened vegetable fatty acid (available under the trade name Pristerene™, ex Croda). Preferred fatty alcohols include tallow alcohol or vegetable alcohol, particularly preferred are hardened tallow alcohol or hardened vegetable alcohol (available under the trade names Stenol™ and Hydrenol™, ex BASF and Laurex™ CS, ex Huntsman).

The weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

The dilute fabric conditioners made by the process of the present invention may comprise additional, non-cationic softening actives. These may be polymeric materials or compounds known to soften materials. Examples of suitable fabric softening actives include: silicone polymers, polysaccharides, clays, amines, fatty esters, fatty N-oxides, dispersible polyolefins, polymer latexes and mixtures thereof.

The fabric conditioners made by the process of the present invention may further comprise additional ingredients suitable for use in fabric conditioner liquids as will be known to the person skilled in the art. Such materials may comprise: antifoams, insect repellents, shading or hueing dyes, preservatives (e.g. bactericides), pH buffering agents, perfume carriers, hydrotropes, anti-redeposition agents, soil-release agents, polyelectrolytes, anti-shrinking agents, anti-wrinkle agents, anti-oxidants, dyes, colorants, sunscreens, anti-corrosion agents, drape imparting agents, anti-static agents, sequestrants and ironing aids. The products of the invention may contain pearlisers and/or opacifiers. A preferred sequestrant is HEDP, an abbreviation for Etidronic acid or 1-hydroxyethane 1,1-diphosphonic acid.

The fabric conditioner compositions made by the process of the present invention are aqueous liquid compositions. The compositions preferably comprise at least 75 wt. % water.

Stability can be assessed by the naked eye. Instability is indicated by flocculation. Flocculation is the formulation of flocs or small lumps on the surfaces of the composition, which occurs when colloids come out of suspension. A stable composition will not form flocs neither lumps in the first 24 hours after production. Flocculation may simply be measured with the naked eye, since for the purposes of this invention, a floc is defined as having a largest diameter of more than 0.1 mm. If no flocculation occurs in a 100 ml sample in the first 24 hours after production, the composition, for the purpose of this invention, is stable.

A suitable method of assessing flocculation is as follows: collect a 1.8 L same of freshly produced product, store for 24 hours at room temperature. After 24 hours dispense 500 ml into a beaker, checking visually for lumps, then dispense the 500 ml into five 100 mm glass petri dishes (100 ml per dish). Assess the samples in the dishes for flocculation. This may be done with the naked eye or with a microscope and micrometer. When using a microscope and micrometer, a floc is defined as having a largest diameter of greater than 0.1 mm.

### Examples

### Process Route A:

Water was heated in a vessel to ˜45° C., the cationic polymer was dispersed therein, followed by the minors. A premix of quaternary ammonium and water was prepared at ˜65° C. and added to the main mix vessel with stirring. The perfume microcapsules and colorant were added. Finally the free oil perfume was added. The composition was then cooled to ˜35° C.

### Process Route 1:

Water was heated in a vessel to ˜45° C., the perfume microcapsules were dispersed therein, followed by the minors. A premix of quaternary ammonium and water was prepared at 65° C. and added to the main mix vessel with stirring. The free oil perfume and colorant were added. Finally the cationic polymer was added. The composition was then cooled to ˜35° C.

Compositions prepared by either process were discharged from the vessel at the same rate, through the same pipeline, which induced the same shear on each composition. They were then left for 24 hours, after which the stability of the formulations was assessed. Stability was assessed by flocculation. Flocculation was assessed visually. Flocculation was deemed to have occurred if visible flocs where identifiable with the naked eye. If flocculation had occurred, this demonstrates an instability in the formulation.

| | Inclusion % wt. of the composition | | | | | |
|---|---|---|---|---|---|---|
| | A | 1 | B | 2 | C | 3 |
| Esterquat¹ | 4 | 4 | — | — | — | — |
| Esterquat² | — | — | 4 | 4 | 4 | 4 |
| Perfume | 0.357 | 0.357 | 0.357 | 0.357 | — | — |
| microcapsule A³ | | | | | | |
| Perfume | — | — | — | — | 0.095 | 0.095 |
| microcapsule B³ | | | | | | |
| Cationic polymer⁴ | 0.21 | 0.18 | 0.21 | 0.18 | 0.21 | 0.18 |
| Perfume A | 0.25 | 0.25 | 0.25 | 0.25 | — | — |
| Perfume B | — | — | — | — | 0.15 | 0.15 |
| Cetyl stearyl | 0.39 | 0.39 | 0.39 | 0.39 | 0.39 | 0.39 |
| alcohol | | | | | | |
| Non-ionic | 0.02 | 0.02 | 0.02 | 0.02 | 0.02 | 0.02 |
| surfactant⁶ | | | | | | |
| Minors | <1 | <1 | <1 | <1 | <1 | <1 |
| Water | To 100 | To 100 | To 100 | To 100 | To 100 | To 100 |
| Process A | X | | X | | X | |
| Process 1 | | X | | X | | X |
| Flocculation | Yes | No | Yes | No | Yes | No |
| observed? | | | | | | |
| | Inclusion % wt. of the composition | | | | | |
| | D | 4 | E | 5 | F | 6 |
| Esterquat¹ | 2.74 | 2.74 | — | — | 2.74 | 2.74 |
| Esterquat² | — | — | 2.74 | 2.74 | | |
| Perfume | 0.357 | 0.357 | 0.357 | 0.357 | | |
| microcapsule A³ | | | | | | |
| Perfume | — | — | — | — | 0.095 | 0.095 |
| microcapsule B³ | | | | | | |
| Cationic polymer⁴ | 0.32 | 0.29 | 0.32 | 0.29 | 0.32 | 0.29 |
| Perfume A | 0.25 | 0.25 | 0.25 | 0.25 | — | — |
| Perfume B | — | — | — | — | 0.15 | 0.15% |
| Cetyl stearyl | 0.39 | 0.39 | 0.39 | 0.39 | 0.39 | 0.39 |
| alcohol | | | | | | |
| Non-ionic | 0.02 | 0.02 | 0.02 | 0.02 | 0.02 | 0.02 |
| surfactant⁶ | | | | | | |
| Minors | <1 | <1 | <1 | <1 | <1 | <1 |
| Water | To 100 | To 100 | To 100 | To 100 | To 100 | To 100 |
| Process A | X | | X | | X | |
| Process 1 | | X | | X | | X |
| Flocculation | Yes | No | Yes | No | Yes | No |
| observed? | | | | | | |

Esterquat¹-Dialkyoxyethyl Hydroxyethyl Methyl Ammonium Methyl Sulphate, wherein the alkyl chains are derived from tallow
Esterquat²-Dialkyoxyethyl Hydroxyethyl Methyl Ammonium Methyl Sulphate, wherein the alkyl chains are derived from palm
Perfume microcapsule A and B³-melamine formaldehyde perfume microcapsules containing different perfume ingredients
Cationic polymer⁴-a Flosoft 270LS polymer ex. SNF
Cetyl stearyl alcohol⁵-Stenol 1618 ex BASF
Non-ionic surfactant⁶-Lutensol AT25 ex. BASF

Compositions prepared flowing process A were inherently unstable, demonstrated by the flocculation after 24 hours. Compositions prepared following process 1 were stable and did not demonstrate flocculation after 24 hours.

1. A process for producing a dilute fabric conditioner, the fabric conditioner comprising:
a. 0.5 to 4 wt. % quaternary ammonium fabric softening active;
b. 0.1 to 4 wt. % perfume microcapsules; and
c. 0.01 to 4 wt. % cationic polymer;
the process comprising the steps of:
i. dispersing the perfume microcapsules in water;
ii. adding the fabric softening active; and
iii. adding the polymer.

2. The process for producing a dilute fabric conditioner according to claim 1, wherein the polymer is added last, other than water, during the process.

3. The process for producing a dilute fabric conditioner according to claim 1, wherein the fabric softening active is pre-dispersed in water prior to addition to make a pre-mix.

4. The process for producing a dilute fabric conditioner according to claim 3 wherein the pre-mix is prepared at a temperature above 50° C.

5. The process according to claim 1, wherein the fabric softening active comprises an ester linked quaternary ammonium fabric softening active.

6. The process according to claim 1, wherein the perfume microcapsules have an encapsulating material which is selected from; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

7. The process according to claim 1, wherein the fabric conditioner comprises at least 75 wt. % water.

8. The process according to claim 1, wherein the cationic polymer comprises a cationic structural units derived from monomers selected from: N, N-dialkylaminoalkyl methacrylate, N, N-dialkylaminoalkyl acrylate, N, N-dialkylaminoalkyl acrylamide, N, N-dialkylaminoalkylmethacrylamide, methacylamidoalkyl trialkylammonium salts, acrylamidoalkylltrialkylamminium salts, vinylamine, inylamine, vinyl imidazole, quaternized vinyl imidazole, diallyl dialkyl ammonium salts, and mixtures thereof.

9. The process according to claim 1, wherein the cationic polymer is a crosslinked water swellable cationic polymer.

10. The process according to claim 1, wherein the cationic polymer is present at 0.01 to 3 wt. % of the fabric conditioner.
